(19) United States
(12) Patent Application Publication
(10) Pub. No.: US 2010/0149669 A1
(43) Pub. Date: Jun. 17, 2010

(54) Method and Apparatus for Combining EUV Sources

(75) Inventor: Daniel G. Smith, Tucson, AZ (US)

Correspondence Address: LAWRENCE R. OREMLAND, P.C., 5055 E. BROADWAY BLVD., SUITE C-214, TUCSON, AZ, 85711, US

(73) Assignee: Nikon Corporation, Tokyo (JP)

(21) Appl. No.: 12/627,088

(22) Filed: Nov. 30, 2009

Related U.S. Application Data
(60) Provisional application No. 61/122,664, filed on Dec. 15, 2008.

(51) Int. Cl. G02B 5/08

(52) U.S. Cl. 359/850; 359/366

(57) ABSTRACT

An apparatus and method is provided, for combining two or more EUV (extreme ultra violet) sources for illumination of a reticle. According to the principles of the present invention two or more EUV sources are combined in a single illumination system, using multiple first mirror arrays, each of which is associated with a respective EUV source, and a single second mirror array defining a pupil, and configured to receive reflected EUV radiation from the plurality of first mirror arrays, and to illuminate the reticle. Preferably, the first mirror array associated with each EUV source has a fly's eye configuration, the single second mirror array has a fly's eye configuration, and a condenser is positioned between the single second mirror array and the reticle. The number of mirror elements in the second mirror array is equal to or greater than the total number of mirror elements in the first mirror array.

### RELATED APPLICATION/CLAIM OF PRIORITY

This application is related to and claims priority from U.S. provisional application Ser. No. 61/122,664, filed Dec. 15, 2008, which provisional application is incorporated by reference herein.

### BACKGROUND

The present invention relates to illumination in an extreme ultraviolet (EUV) imaging system, and particularly to an illumination concept for increasing EUV illumination power for an EUV application such as EUV lithography.

EUV lithography is an emerging technology that is designed to shrink the size of features that can be printed (imaged) by an imaging system, using illumination in the EUV (11-14 nm) wavelength range. In an EUV lithography imaging system, an EUV source (e.g. from a laser produced plasma, known in the art as LPP, or a discharge produced plasma, known in the art as DPP) is generally produced in a vacuum environment, and illuminates a reticle that is then imaged to a photo resist via a projection system that comprises a series of projection optics. The principles of the present invention are particularly useful with an LPP source, because that source tends to be smaller than a DPP source.

In EUV lithography, since optical elements of the system (including the reticle) tend to absorb EUV light. Thus, an EUV lithography system tends to be strongly light limited by the optical elements of the system; hence the optical elements of the system can cause the power of the illumination source to be significantly reduced.

### SUMMARY OF THE PRESENT INVENTION

The present invention addresses the issue of the light limitations of an EUV system, by providing illumination structure and method designed to increase the amount of light in an EUV lithography system.

More specifically, the present invention provides a structure and method for combining two or more EUV (extreme ultra violet) sources for illumination of an EUV reticle, in a manner that counteracts the reduction of illumination power due to absorption of EUV light by the optical elements of the structure. In a preferred embodiment, the present invention uses certain aspects of a fly's eye illumination system to combine the source power in the pupil of the EUV illumination system, in a manner that increases the amount of light in the illumination system.

According to the principles of the present invention two or more EUV sources are combined in a single illumination system, using multiple first mirror arrays, each of which is associated with a respective EUV source, and a single second mirror array configured to receive reflected EUV radiation from the plurality of first mirror arrays. The second mirror array defines a pupil, and a reticle defining a pattern is configured to receive illumination from the second mirror array. A projection system (comprising an array of projection optics) is configured to use the EUV radiation received at the reticle to pattern a substrate with the defined pattern.

Preferably, the first mirror array associated with each EUV source has a fly's eye configuration, and the single second mirror array has a fly's eye configuration. The number of mirror elements in the second mirror array is equal to or greater than the total number of mirror elements in the first mirror array.

These and other features of the present invention will be apparent from the following detailed description and the accompanying drawings.

### BRIEF DESCRIPTION OF THE DRAWINGS

FIG. 1 is a schematic illustration of a typical fly's eye illumination system for a lithographic imaging optical system; and

FIG. 2 is a schematic illustration of an EUV illumination structure and method, according to the principles of the present invention.

### DETAILED DESCRIPTION

As described above, the present invention provides an illumination structure and method for EUV illumination of a reticle. The structure and method of the present invention described herein utilize known types of EUV wavelength source(s) that produce EUV radiation in a vacuum environment, and structure and method of the present invention is designed to utilize the EUV wavelength sources to illuminate a reticle. The EUV sources may be e.g. of a laser produced plasma (LPP) or discharge produced plasma (DPP) type, both of which are known to those in the art. Because the LPP source is smaller, it is contemplated that the principles of the present invention are more likely to be utilized with an LPP as the EUV source.

In this application, the term “reticle” is intended to encompass a component with a pattern that is illuminated as it is imaged to a substrate, including a refractive component as well as a reflective component, as will be recognized by those in the art.

In a typical EUV fly's eye illumination system, the radiation from a single source (e.g. a laser generated plasma) is directed, by means of some collection optics, to an array of mirrors each having an aperture that is the same shape as the desired illumination pattern on the reticle. Each of the mirrors in the first mirror array directs a portion of the radiation to an associated mirror in a second mirror array. The association between mirrors in the two arrays is such that there is one mirror in the second array for every mirror in the first array. The second mirror array is positioned in the pupil of the condenser optics. The condenser optics direct radiation from the second mirror array to the reticle such that the images of all of the apertures of the first mirror array are overlapping, thereby producing a very uniform irradiance pattern on the reticle.

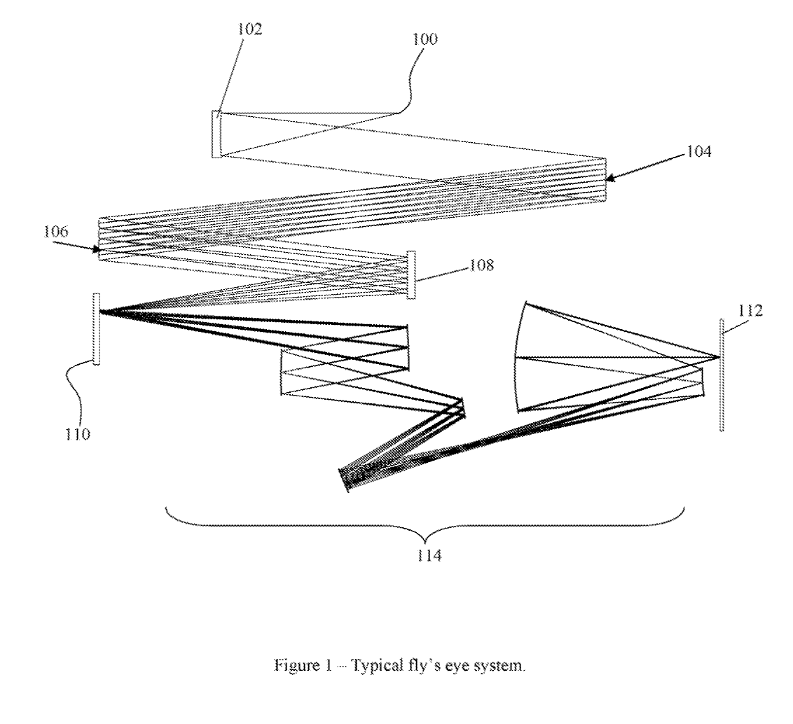

FIG. 1 schematically illustrates a typical fly's eye system (e.g. in a lithographic imaging system for imaging a substrate 112 such as a semiconductor wafer). In FIG. 1, beginning with the source 100 (or intermediate focus after the collection optics), the light reaches a collimator 102 and is sent to the first fly's eye 104, which forms images of the source at each element in a second fly's eye 106. Each element of the second fly's eye generates a real image of the first fly's eye, through a condenser element 108, on the reticle 110. The reticle is imaged to an image plane (e.g. of the substrate 112) with a projection system that includes projection optics (like the 6 mirror projection optics shown schematically at 114 in FIG. 1). The condenser element 108 also images the second fly's eye 106 into the entrance pupil of the projection optics, e.g. through reflection by the reticle 110.

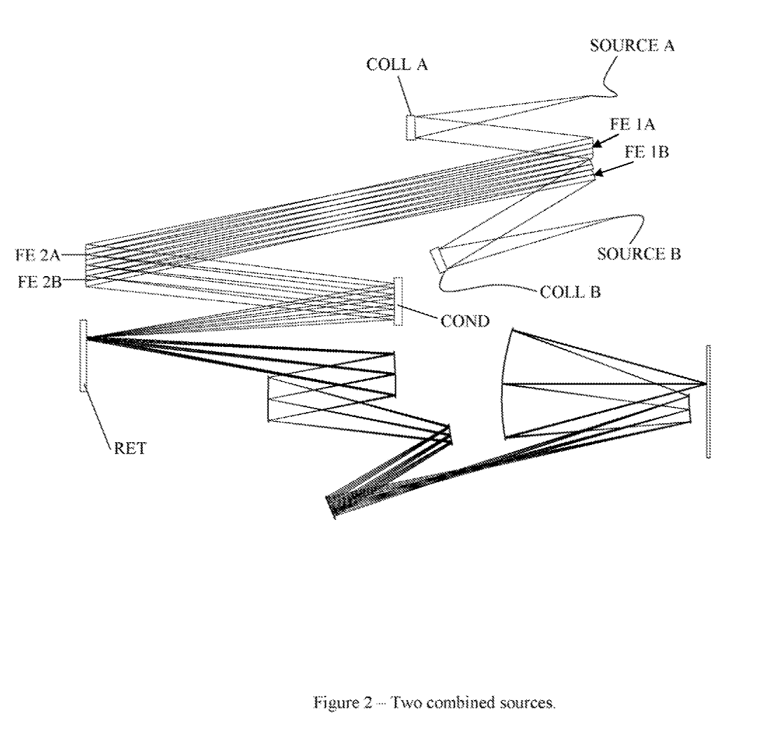

A system and method for producing EUV illumination of a reflective mask or reticle, in accordance with the principles of the present invention are schematically illustrated in FIG. 2. According to the present invention, each a plurality of EUV sources is provided (FIG. 2 illustrates two EUV sources, labeled “source A” and “source B”). A plurality of first mirror arrays is provided, each of with is configured to receive and reflect EUV radiation from a respective EUV source. In FIG. 2, the first mirror array associated with source A is labeled FE1A, and the first mirror array associated with source B is labeled FE1B.

Light leaving each of the first mirror arrays is directed to a single second mirror array. The portion of the second mirror array associated with source A is labeled FE2A and the portion of the second mirror array associated with source B is labeled FE2B. In the example of FIG. 2, a collimator (coll A) is associated with EUV source A, and a collimator (coll B) is associated with EUV source B. The association between mirror elements in the first mirror array FE1A, FE1B and the second mirror array FE2A, FE2B are such that each mirror element in the first array has an associated single element in the second array. That is, the number of elements in the second mirror array is equal to or greater than the total number of elements among the first mirror arrays.

Each of the dedicated first mirror arrays FE1A and FE1B has a fly's eye configuration. The mirrors would preferably have the shape of the desired illumination slit, and the mirror surfaces would be as highly reflective as possible (using multi layer coatings), as will be recognized by those in the art. Moreover, the single second mirror array (formed of FE2A and FE2B) also has a fly's eye configuration. In addition, the single second mirror array defines a pupil, and the condenser COND is positioned between the second mirror array and the reticle RET.

The example of FIG. 2 only shows four channels of the fly's eye; however, the illumination concepts of this invention allow significant complexity by the illumination system. For example, it is possible to direct the beamlets by setting the direction of the first mirror array elements so that light from each source is dispersed throughout the pupil defined by the second mirror array.

Although FIG. 2 shows the case where the collector optics include separate collector collimators coll A, coll B, it is possible to eliminate the collimators, or rather include them in the first fly's eye FE1A, FE1B. Also, the first fly's eye could serve as the collection optics.

The condenser optics image the second fly's eye to the entrance pupil of the projection optics through reflection by the plane of the reticle RET. In designs where the entrance pupil of the projection lens is located in the optical space preceding the reticle, the role of the condenser lens COND can be incorporated into the second mirror array FE2A, FE2B. In this case, the each mirror in the second mirror array is rotated to direct an image of its associated mirror element one of the first mirror arrays to overlapping positions on the reticle.

Thus, the invention provides a structure and method for combining two EUV sources in a single illumination system. The above description shows how this is possible in several illumination system arrangements using multiple first mirror arrays and a single second mirror array at the pupil of the illumination system.

This invention is useful in the event that a single EUV source does not provide enough power for the desired throughput since it could increase the throughput by as many sources as can be combined, so long as the étendue of the collectors of the EUV sources (i.e. the optics that include the first and second mirror arrays that collect and transmit radiation from the EUV sources) is less than or equal to the étendue of the projection optics.

Accordingly, the foregoing description provides a structure and method that increases the amount of light available for an EUV lithography system, by combining two or more EUV sources in a single illumination system, using multiple first mirror arrays, each of which is associated with a respective source, and a single second mirror array that receives reflected EUV radiation from the first mirror arrays, and reflects the EUV radiation in a manner that illuminates a reticle . With the foregoing description in mind, various ways in which the manner in which the amount of light available for an EUV illumination system can be increased, using the principles of the present invention, will be apparent to those in the art.

1. An apparatus, comprising:
a plurality of EUV illumination sources;
a plurality of first mirror arrays, each configured to receive and reflect illumination from a respective EUV illumination source;
a single second mirror array, configured to receive reflected EUV radiation from the plurality of first mirror arrays, the single second mirror array defining a pupil;
a reticle defining a pattern, and configured to receive reflected EUV illumination from the single second mirror array; and
a projection system configured to use the EUV illumination received at the reticle to pattern a substrate with the defined pattern.

2. The apparatus of claim 1, further comprising a condenser, positioned between the single second mirror array and the reticle.

3. The apparatus of claim 2, wherein each of the first mirror arrays comprises a plurality of first mirror elements, wherein the single second mirror array comprises a plurality of second mirror elements, and each first mirror element in each of the first mirror arrays has an associated single second mirror element in the second mirror array.

4. The apparatus of claim 3, wherein each of the first mirror arrays has a fly's eye configuration, and wherein the single second mirror array has a fly's eye configuration.

5. The apparatus of claim 4, wherein the number of second mirror elements in the second mirror array is equal to or greater than the total number of first mirror elements in the first mirror arrays.

6. The apparatus of claim 1, wherein the projection system includes projection optics, and wherein the étendue of the collectors of each of the EUV sources is less than or equal to the étendue of the projection optics.

7. The apparatus of claim 1, including condenser optics that image the single second mirror array to an entrance pupil of the projection system.

8. A method of illuminating a reticle of a projection system, the method comprising
a. providing (i) a plurality of EUV sources, (ii) a plurality of first mirror arrays, each of the first mirror arrays configured to reflect illumination from the plurality of EUV illumination sources respectively, (iii) a single second mirror array, configured to reflect EUV radiation received from the plurality of first mirror arrays, the single second mirror array defining a pupil, (iv) a reticle defining a pattern, and configured to receive reflected EUV illumination from the single second mirror array, and (v) a projection system configured to use the reflected EUV illumination received at the reticle to pattern a substrate with the defined pattern; and
b. illuminating the reflective reticle by means of the reflected EUV illumination from the single second mirror array.

9. The method of claim 8, including providing a condenser positioned between the single second mirror array and the reticle.

10. The method of claim 9, wherein each of the first mirror arrays comprises a plurality of first mirror elements, the single second mirror array comprises a plurality of second mirror elements, and each first mirror element of the first mirror arrays has an associated single second mirror element in the second mirror array, and wherein in illuminating the reflective reticle radiation from each first mirror element of the first mirror arrays is directed to an associated single mirror element in the second mirror array.

11. The method of claim 10, wherein each of the first mirror arrays has a fly's eye configuration, and wherein the single second mirror array has a fly's eye configuration

12. The method of claim 11, wherein the number of second mirror elements in the second mirror array, is equal to or greater than the total number of first mirror elements in the first mirror arrays.

13. The method of claim 8, wherein the single second mirror array is imaged by condenser optics to an entrance pupil of the projection system.

14. The method of claim 8, wherein the projection system includes projection optics, and wherein the étendue of the collectors of each of the EUV sources is less than or equal to the étendue of the projection optics.
